(19) United States
(12) Patent Application Publication
(10) Pub. No.: US 2022/0327652 A1
(43) Pub. Date: Oct. 13, 2022

(54) MULTI-MODAL MOBILITY MANAGEMENT SOLUTIONS FRAMEWORK

(71) Applicant: Hitachi, Ltd., Tokyo (JP)

(72) Inventors: Malarvizhi SANKARANARAYANASAMY, Mountain View, CA (US); Ramyar SAEEDI, Santa Clara, CA (US); Rahul VISHWAKARMA, Sunnyvale, CA (US); Prasun SINGH, San Jose, CA (US); Ravigopal VENNELAKANTI, San Jose, CA (US)

(73) Assignee: Hitachi, Ltd.

(21) Appl. No.: 17/225,795

(22) Filed: Apr. 8, 2021

(51) Int. Cl. G06Q 50/30; G06K 9/62; G06N 20/00

(52) U.S. Cl. CPC G06Q 50/30; G06K 9/6262; G06K 9/6289; G06N 20/00

(57) ABSTRACT

Systems and methods described herein can involve establishing a blockchain network between a plurality of organizations, each organization representing a different mode of transport and/or transit oriented service providers; deriving multi-modal features from first data sources of the plurality of organizations in the blockchain and second data sources off the blockchain; constructing a multi-modal network that integrates the different mode of transports from the plurality of organizations from the derived multi-modal features; executing smart contracts between the plurality of organizations across the blockchain in accordance with service level agreements generated from reinforcement learning through the multi-modal model derived from the multi-modal network; and providing, through a micro-application, access to multi-modal transportation services based on the executed smart contracts.

### BACKGROUND

### Field

The present disclosure relates generally to solution frameworks, and more specifically, to solution frameworks that manage multi-modal transportation system (for mobility).

### Related Art

The future travel trends, such as in cities, indicate a passenger preference towards multi-modal mobility. Multi-modal mobility involves two or more modes of transportation to reach a desired destination. In the related art, transit networks have been operated in their silos with minimal or no interaction between the transit service providers. The related art transportation ecosystem with an isolated control tower structure has led to resource redundancy and operational inefficacy.

### SUMMARY

Larger transit networks, such as train, bus and rapid transits, require an effective interface to integrated and/or synchronize their operations within themselves and also with the micro-mobility services to ensure first mile and last mile connectivity and to provide a seamless transit experience to the passengers. Example implementations described herein facilitate multi-modal mobility management solutions for reducing operational and/or transaction friction loss in a transit network while integrating multi-modal transportation services.

The example implementations described herein address data aggregation, analysis, and representation for the multi-organizations participating in a multi-modal ecosystem. Some of the specific problems faced for multi-modal transport network integrated operation are addressed as follows.

Example implementations described herein facilitate detailed solutions for a secured asset (e.g., physical and data) sharing/interchange infrastructure for a multi-modal transportation ecosystem that does not presently exist in the related art transportation network implementations.

Example implementations described herein facilitate a mixed time window and volume variation handling for resource allocation. Different modes of transit have a varied resolution and flexibility for operational parameters such as time, capacity, and so on. Hence, synchronizing and/or incentivizing multi-modal operations require systems and methods to handle these variations.

Example implementations can also facilitate flow linearization and transit hub turbulence reduction, transitioning from the related art hub and spoke model which creates congestion and centralization of the transit networks. Such related art implementations also lead to inefficient and ineffective usage of resources.

Example implementations facilitate complex system-of-system optimization and efficient resource allocation in both the modular and integrated incentivized framework.

Aspects of the present disclosure can involve a method, which can involve a method for establishing a blockchain network between a plurality of organizations, each organization representing a different mode of transport; deriving multi-modal features from first data sources of the plurality of organizations in the blockchain and second data sources off the blockchain; constructing a multi-modal network that integrates the different mode of transports from the plurality of organizations from the derived multi-modal features; executing smart contracts between the plurality of organizations across the blockchain in accordance with service level agreements generated from reinforcement learning through the multi-modal model derived from the multi-modal network; and providing, through a micro-application, access to multi-modal transportation services based on the executed smart contracts.

Aspects of the present disclosure can involve a system, which can involve means establishing a blockchain network between a plurality of organizations, each organization representing a different mode of transport; deriving multi-modal features from first data sources of the plurality of organizations in the blockchain and second data sources off the blockchain; means for constructing a multi-modal network that integrates the different mode of transports from the plurality of organizations from the derived multi-modal features; means for executing smart contracts between the plurality of organizations across the blockchain in accordance with service level agreements generated from principal policy framework from the co-operating entities and/or from reinforcement learning through the multi-modal model derived from the multi-modal network, and means for providing, through a micro-application, access to multi-modal transportation services based on the executed smart contracts.

Aspects of the present disclosure can involve a computer program, which can involve instructions involving establishing a blockchain network between a plurality of organizations, each organization representing a different mode of transport; deriving multi-modal features from first data sources of the plurality of organizations in the blockchain and second data sources off the blockchain; constructing a multi-modal network that integrates the different mode of transports from the plurality of organizations from the derived multi-modal features; executing smart contracts between the plurality of organizations across the blockchain in accordance with service level agreements generated from reinforcement learning through the multi-modal model derived from the multi-modal network; and providing, through a micro-application, access to multi-modal transportation services based on the executed smart contracts. The computer program can be stored on a non-transitory computer readable medium and configured to be executed by one or more processors.

Aspects of the present disclosure can involve an apparatus, which can involve a processor configured to establish a blockchain network between a plurality of organizations, each organization representing a different mode of transport; derive multi-modal features from first data sources of the plurality of organizations in the blockchain and second data sources off the blockchain; construct a multi-modal network that integrates the different mode of transports from the plurality of organizations from the derived multi-modal features; execute smart contracts between the plurality of organizations across the blockchain in accordance with service level agreements generated from reinforcement learning through the multi-modal model derived from the multi-modal network; and provide, through a micro-application, access to multi-modal transportation services based on the executed smart contracts.

### BRIEF DESCRIPTION OF DRAWINGS

FIG. 1(A) illustrates a mono-modal operational process in accordance with the related art.

FIG. 1(B) illustrates a multi-modal operational process, in accordance with an example implementation.

FIG. 2 illustrates the hierarchical framework for multimodal mobility service execution, in accordance with an example implementation.

FIGS. 3 and 4 illustrates an example of the transit network data analysis, in accordance with an example implementation.

FIG. 5 demonstrates the decentralized system interaction between the partners in a multimodal mobility ecosystem, in accordance with an example implementation.

FIG. 6 illustrates the framework deployment strategy that facilitates an interoperable interface between the modes of transit and ensures a single truth visibility across the travel value chain, in accordance with an example implementation.

FIG. 7 illustrates an example of sample services and outputs through the framework proposed herein.

FIG. 8 illustrates an example workflow of the system in accordance with an example implementation.

FIG. 9 illustrates an example execution between MMM planners and an operations manager, in accordance with an example implementation.

FIG. 10 illustrates an example workflow for the analytics, in accordance with an example implementation.

FIG. 11 illustrates examples of functional decisions, in accordance with an example implementation.

FIG. 12 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

Example implementations described herein facilitate a solution framework that involves a single truth platform for a multi-agent transportation service network. The proposed solution framework acts as an interface between two or more transit operators and/or service providers which otherwise would have operated in isolation by the mode specific control tower. The proposed solution further details the method for secured data ingestion, aggregation and sharing of data and corresponding analysis results for a transit network operation leveraging the information from the partners and open source data. The results of data analysis can be leveraged for developing integrated and/or new services within the transportation ecosystem.

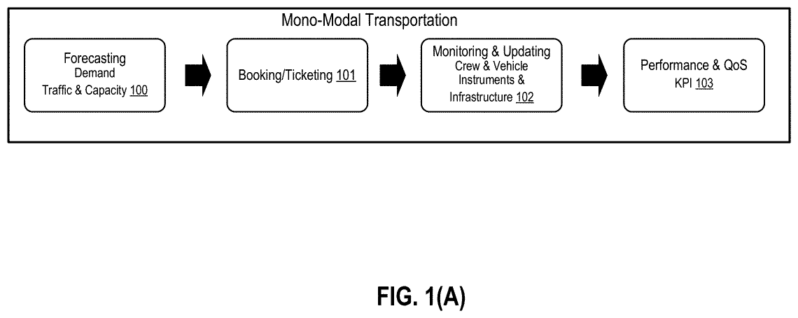

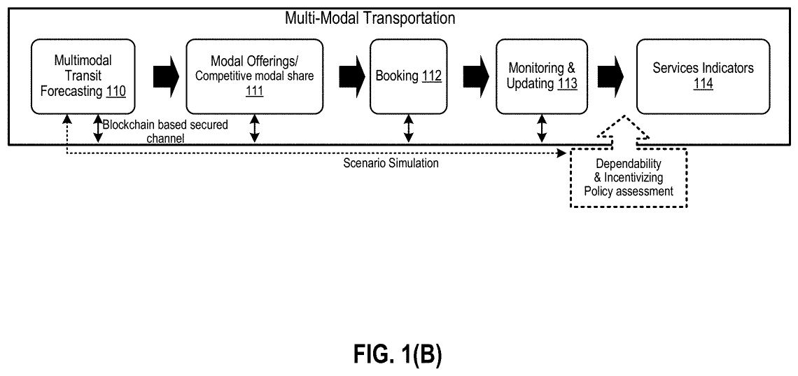

The features of the multi-modal transportation solutions framework proposed herein can be understood by comparing mono-modal and multi-modal operational process flow as shown in FIGS. 1(A) and 1(B).

FIG. 1(A) illustrates a mono-modal operational process in accordance with the related art. In the mono-modal operational process, the system first forecasts demand traffic and capacity at 100, executes booking/ticketing based on the forecast at 101, monitors and updates crew, vehicle instruments, and infrastructure accordingly at 102, and then monitors the performance and quality of service (QoS) key performance indicators (KPIs) at 103. Hence, the related art mono-modal transit network operation involves mode specific forecasting and allocation of resources followed by booking and utilization monitoring of the resource for successive trips. Finally, performance of the mono-transit network is reported based on mode specific parameters.

FIG. 1(B) illustrates a multi-modal operational process, in accordance with an example implementation. In the flow of the multi-modal operational process, the system first executes multi-modal transit forecasting 110, determines multi-modal offerings based on a competitive modal sharing system (e.g., as determined by operations cost, energy capacity, resources, etc.) 111, facilitates the booking across multi-modal transportation at 112, monitors and updates the system based on the multi-modal transportation booking 113, and provides services indicators 114. The services indicators can include, but are not limited to, multimodal mobility KPIs, modal penetration, modal share, and added revenue/sources. To facilitate each portion of the flow, a scenario simulation is executed through a blockchain based secure channel for each of the flows to ascertain dependability and to provide feedback regarding the assessment of incentivizing policies applied across the multi-modal transportation systems to participate in the system. Such simulations can facilitate the determination of threats, attributes, and solutions.

Example implementations described herein provide for a multimodal solution framework, which can facilitate a platform for multimodal transit across one trip modeled in a trip link. Example implementations involve an intake of data from the trip planning and other sources to build a backend for the transit operators to engage. To facilitate the backend, multimodal travel is paired with multimodal operation in a collaborative manner. Current transport operations operate in their own siloes with specific forecasting models only for a particular mode of transit.

Further, example implementations facilitate the documenting, booking and ticketing of travel across multimodal transportation, wherein the asset management functions conduct monitoring and updating across all modes of transportation as opposed to a single mode of transportation.

The proposed multi-modal solution involves the following features that address the challenges involved in the transition from mono-mode centric siloed operation towards realizing the benefits for multi-modal integrated operations.

Decentralization and multi-organizational engagement: Data from multiple transit networks organizational verticals are aggregated, analyzed and represented. Blockchain technology is used to secure organization interest and ensure single truth establishment. Micro-services for different stakeholders are deployed as micro-applications and monitored via Internet of Things (IoT)-smart contacts to ensures privacy and security while retaining single truth visibility across the travel value chain.

Collaborative Co-optimization: Multi-modal forecasting and planning activity for resource allocation are conducted based on the data and policy inputs from two or more participating entities. Here, a modular market driven co-optimization strategy is employed to develop self-adaptive network solutions that augments for friction loss during transition between modes. This also facilitates transportation networks to share demand-supply signals in different segments of a travel chain.

Modal-offerings: A unique feature in a multi-modal transit framework. The procedure evaluates the competitive offering from different transit operators and service providers in a multimodal ecosystem and disambiguates resources/service allocation.

Mobility integrators: Framework for multi-organization interaction to develop and evaluate new policy frameworks between participating transit operators and/or service providers to incentivize integrated operations and data exchange. This may include new ticketing service bundle creation for passengers, infrastructure and energy, IoT data sharing strategy between micro and macro mobility services, and so on.

Dependable decision support: an entity of the solution framework that provides methods to detect, provide early warning and handle data and operational uncertainties. Scenario based simulation methods are employed to augment data uncertainties and enable operational decision assistance.

Multi-modal monitoring, inspection and safety: Multi-modal sensor and operation data extraction and analysis.

Example implementations involve a framework that provides system and methods to ingest, aggregate, analyze and represent multimodal spatio-temporal data from macro and micro transportation modes. Sensor, operational, regulatory, survey, and other data from multiple organizations are aggregated and utilized.

The framework is configured to connect disparate systems and establish single truth visibility to operations (example: data governance for demand-supply signal) among partners in multimodal travel value chain using blockchain technology. The framework is also configured to execute smart-contracts for payment disambiguation, broadcast/share asset availability, service dependability, and other service level agreements (SLAs). The framework offers a co-optimization of modular market-driven demand-supply signals and operational resources to ensure seamless transit experience for users.

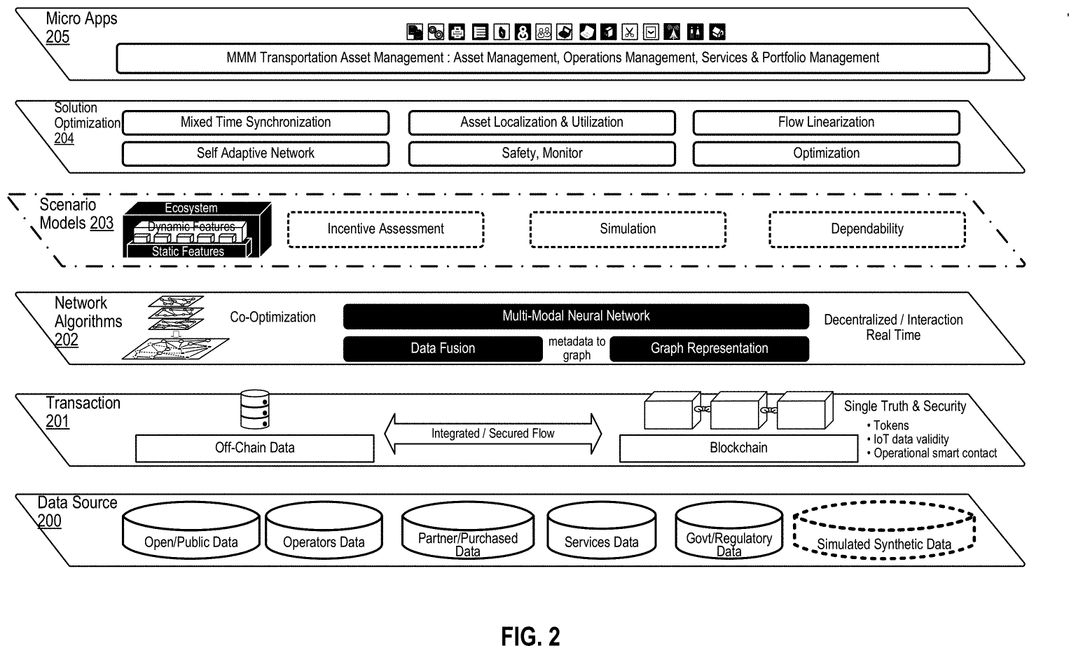

FIG. 2 illustrates the hierarchical solution framework for multimodal mobility (MMM) service execution, in accordance with an example implementation.

The first part of the framework involves a data management method for multiple data sources 200 to create an interoperable interface. The data from multiple sources can include, but are not limited to, mono-modal transportation operators/service providers, private/public/open source data such as weather, special events, government regulatory information, and surveys are ingested into a combination of blockchain and off-chain databases.

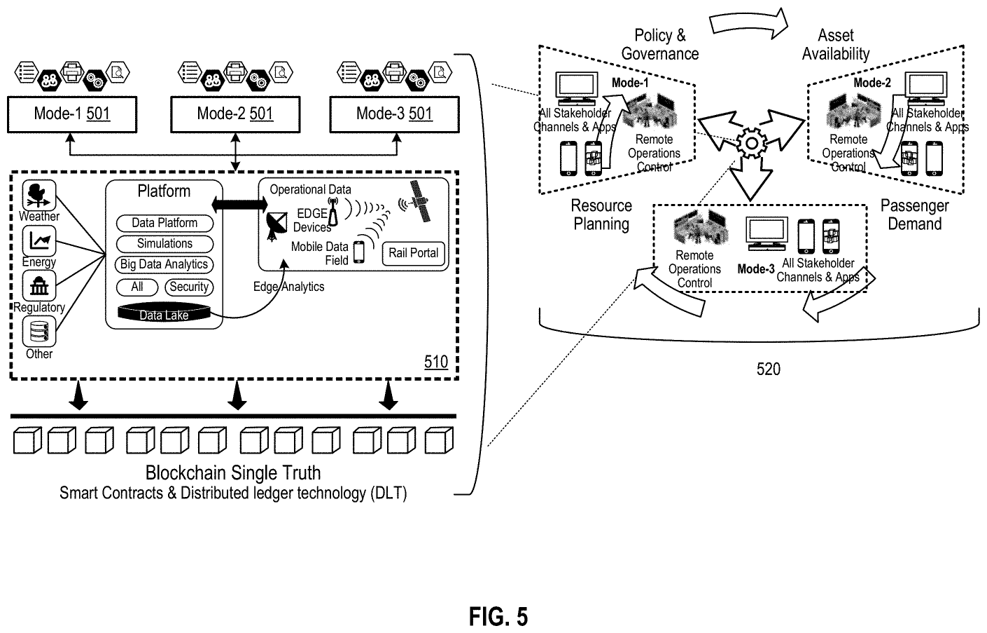

The next part of the framework involves a system to facilitate transactions 201 across multiple organizations of monomodal transit companies. Due to the inherent competition for passengers by monomodal transit companies, there needs to be a permissioned and decentralized way to share information and the need to establish single truth among MMM partners. To address this need, example implementations utilize a blockchain based interface that enables such onboarding/off-boarding of partners for a MMM setup. This solution provides data based on data governance established by an MMM blockchain consortium and is capable of developing, verifying and validating smart contracts for the MMM blockchain consortium. Some of the plausible information exchange that could happen over blockchain channel may include: transit asset/passenger demand and supply information exchange, asset availability, dependability of services and asset and other SLAs. The framework via blockchain network provides a functional interface to integrate and synchronize the operations of more extensive transit networks (e.g., train-bus-rapid transits) within themselves and also with the micro-mobility services to ensure first and last mile connectivity from a customer perspective. Additionally, the transaction layer of the framework facilitates the flow of off-chain data into the blockchain as needed. Further details of the blockchain are provided with respect to FIG. 5.

Network scenario and optimization layers 202 of the framework includes the analytical and simulation models developed for multimodal transit services. The framework services leverage analytical models, more specifically machine learning (ML) models for integrated operations of a multimodal, decentralized, distributed market-based co-optimization solution for demand-supply matching, collaborative co-optimization policies, and service disruption management, as well as facilitating seamless AI agent-based payment disambiguation between different modal operators.

For scenario modeling 203, this layer presents the simulation environments that aids in high dimensional experimental scenario-based analysis. Two main functionalities developed in this layer include dependability analysis and incentive assessment systems. Simulation based dependability analysis preemptively detect faults, provide early warning signals, assess the impact of possible failures and provide counteractive measures. The simulation setup for incentive assessment is aimed at testing controlled experimental policy frameworks for both transit service providers and passengers. Simulation tools are also employed to accommodate data uncertainty during initial analytical model development, to evaluate network limits and dependability. The framework can also be used to fuse multi-modal sensor data and evaluate multi-modal transit system KPIs. In the example implementation of FIG. 2, two sets of scenario simulation models for dependability and incentive assessment are employed. Dependability assessment is used for network operations threat identification, attribute (Operational Parameter) analysis, prescriptive solution development, and so on.

Further, a reinforcement learning based incentive assessment model is used for incentivizing policy generation and to represent the multiple stakeholder interest representation on decision analytic outputs from the simulation layer, which can be in the form of the format Graph-DB, Policy and environmental parameters. The framework also provides data driven AI/ML models to develop incentivized co-operational policies for the transit operators/service providers. Such models can involve a multimodal network flow and operational analysis model to capture the coupling between two or more transportation operators/service providers so as to minimize operational inefficiency and improve rider experience. Leveraging AI models, the example implementations facilitate a joint pricing scheme and revenue reallocation principle that allows to achieve the modal share maximization. The dependability assessment model has the following functionality: Threat/Risk Identification, System reliability monitoring and estimation, Risk based failure consequence estimation, Uncertainty analysis, Attribute (Operational Parameter) Analysis, and Prescriptive Solution Development. Further details of the dependability assessment model are provided with respect to FIG. 4.

For the solution optimization layer 204 of the framework, various algorithms can be employed to facilitate optimization of the solutions generated from the model and from the reinforcement learning. Such techniques can include, but are not limited to, mixed time synchronization, asset localization and utilization, flow linearization, self-adaptive network, safety/monitoring, and so on.

For the micro-service application layer 205, various micro-services can be provided as micro-applications depending on the desired implementation. For example, such micro-applications can involve output services such as optimized fleet sizing/composition, empty vehicle repositioning problems, fleet deployment, fleet inventory control. Service indicators can involve resource allocation and optimization and aligned with KPIs. Fleet Routing can involve traffic/congestion reduction, fleet energy consumption minimization, and so on. Fleet Monitoring and Updating can involve IoT, Fleet mileage performance updating, and asset depreciation and rating. Modal offering can involve modal shared prediction and allocation. Multimodal data aggregators can facilitate public and private multi-domain data alignment. Demand forecasting can involve traveler behavior analysis through surveying, and from real time anonymized mobile data. Thus, the solutions are delivered to stakeholders as micro-services that focus on particular/desired data and provide KPIs as desired.

Example implementations also provide for an incentive assessment system. This is a multi-agent game theory-based scenario modeling system which provides incentivizing policy framework for collaborating multi-organizational entities. Key features of this models can include policy and environment assessment, incentivizing policy generation, and stakeholder interest representation on decision analytics.

As illustrated in FIG. 2, the framework as proposed herein is a multi-layered function framework in which the data source layer 200 are directed to the data management and blockchain facilitation, the transaction 201, network algorithms 202 and scenario models 203 are the examples of the services that can be developed from the framework. Finally, the solution optimization 204 and the micro applications 205 facilitate functions such as a booking system for each of these modes of transport that then combine monitoring and updating service and service indicators for a combined multi-modal ecosystem.

Through the example implementations, a network algorithm is generated in the form of a graph neural network (GNN) to provide a representation of different transit modes. The advantage of such a representation is that the example implementations can handle individual modes in a modular way and also based on the smart contract-based agreements between two organizations (e.g., bus and train) and agree to optimize some of their resources or event schedule timing. Together they can opt to co-optimize their operations, which can involve synchronization of a bus schedule with the train schedule for a particular period of time through the use of a graph neural network.

Example implementations also capture data that will be given as features in the modes of each GNN. The representation of the different modes can be formed, and then a unified network is created in a modular manner. Models can be created for sensor and data fusion to form a multi-modal graph neural network from which simulations can be executed. The objective of the simulation is to evaluate the dependability of the services. For example, a simulation can involve a service construction scenario in which various modes transport can diverge and the simulation determines if train service disruption also occurs based on the divergence of the other affected modes of transport.

Through the framework, the present instant and real-time assessment can be facilitated, and solution optimizations can be facilitated to handle volume over time, as well as for disruptions in modes of transportation through identifying alternate multi-modal routes. The simulations through the graph models can determine alternate paths and alternate solution units in terms of mode or refund structure.

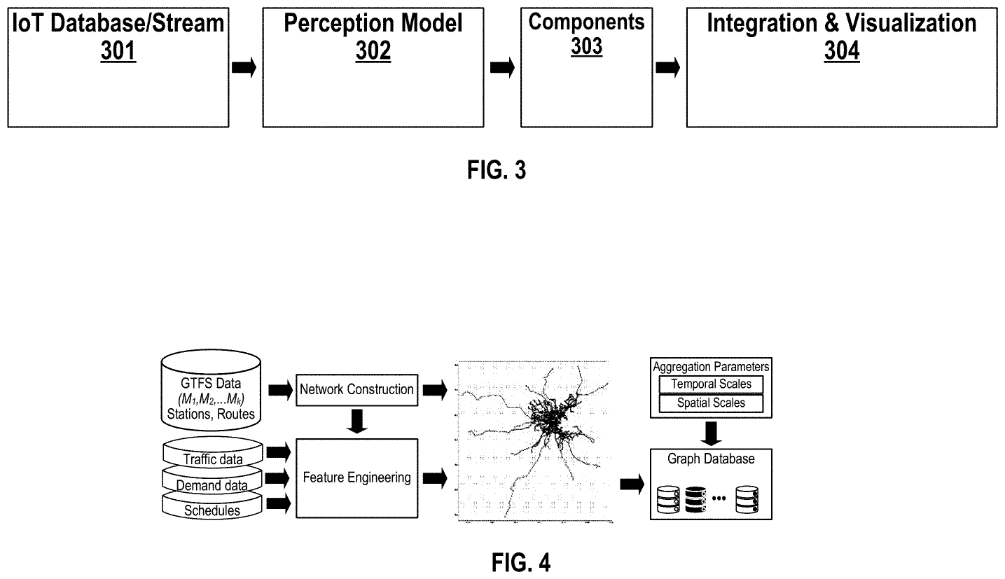

FIGS. 3 and 4 illustrates an example of the transit network data analysis, in accordance with an example implementation. FIG. 3 illustrates an example flow of the data and components that are utilized for the integration and visualization of the assets as well as the resulting graph model. At first, an IoT database/stream 301 is aggregated into the data lake, which can conduct sensor fusion and include functions such as a data channel manager, data synchronization, real-time inference, training/validation, image frame and associated metadata, along with processes to determine camera pose, sensor data and global positioning satellite (GPS) data.

The processed data from the IoT database/stream 301 processing on the datalake is provided to a perception model 302, which can involve functionality to facilitate recognition/detection models, task specific analysis heads, evaluation and accuracy processes, performance and bias determination, count/density estimation, and temporal estimation.

The output of the perception model 302 can be reduced to components 303 for visualization, such as people count, crowd density, asset location, asset quality, map assets and monitor time.

Integration and Visualization 304 intakes and integrates the output from the components 303 to provide visualization as illustrated in FIG. 4. Such functionality can include, but is not limited to, a map-based visualization of assets, crowd density and heatmap over time, asset location and quality over time, to monitor asset degradation and crowds, feedback on quality/quantity accuracy, and integration with downstream analytics and database.

FIG. 4 illustrates an example output of how the different flows of FIG. 3 are used for integration and visualization of an example rail system. Specifically, FIG. 4 illustrates how sensor data can be combined to facilitate integration/visualization and dependability analysis. Data such as traffic data, demand data, schedules, General Transit Feed Specification (GTFS) data for stations and routes, and so on, which is used for feature extraction for the models and network construction for the transit network model generation, which is visualized to the corresponding component. The visualization can be stored in the graph database so that subsequent data from aggregation parameters over space and time can be fed into the graph for further visualization in real time.

FIG. 5 illustrates the decentralized system interaction between the partners in a multimodal mobility ecosystem, in accordance with an example implementation. In the example implementations, the framework facilitates blockchain-based decentralized and multi-organizational engagement with distributed ledger technology (DLT). This allows the framework to manage multi-organizational interest, co-optimization through collaborative engagement and incentivizing multi-organization participation. The blockchain itself can be generated using techniques as known in the art, however, for the purposes of the present framework, the blockchain is generated for organizations 501 with each organization 501 representing a different mode of transport (bus, rail, boat, etc.).

The blockchain can be facilitated on a platform 510 which can be constructed in accordance with the desired implementation through the use of known techniques. The platform 510 can be configured to not only intake blockchain data from the organizations 501 into its data lake, but also manages off-chain data, such as, but not limited, weather data, energy data, regulatory information, and so on in accordance with the desired implementation. Such off-chain data can involve high volume and high frequency data to be stored, and can be digitally stored by the platform 510 via the datalake or within the stakeholder systems to form smart contacts. The platform 510 can also function as an IoT platform to intake operational data from edge devices, mobile devices, rail portals, and so on. Through such implementations, all of the data can be aggregated by the platform 510 into a standardized presentation despite differing time resolutions, volume parameters, and so-on.

As illustrated in FIG. 5, the platform 510 can facilitate the exchange and delivery of service level agreements through smart contracts between the organizations. The platform 510 and the blockchain implementation 520 on the platform 510 allows for decentralization and multiple organizations within the blockchain 520, in which each organization can manage their own applications, stakeholder channels, and operations control. Further, such implementations allow for the organizations to form groups and subgroups within the consortium so that the organizations do not have to involve all levels for a particular contract, or so that task-specific functionality can be implemented. Each organization can form channels and engage to other organizations or sub-groups for a particular task, and populate a smart contract in accordance with their rules of engagement. Blockchain implementations are utilized to envelop the data sets required for a particular task which the two or more organizations have agreed to cooperate on and those networks, channels, and smart contracts are optimized for either saving time costs or space-specific costs.

In example implementations, the objectives between the organizations can involve time cost savings, space cost savings, and so on. Based on such objectives, the multi-modal system can use the open source data with the partner data to develop competitive modal offerings in the ecosystem as demanded, and does not need to incorporate all of the multi-modal operators in the system.

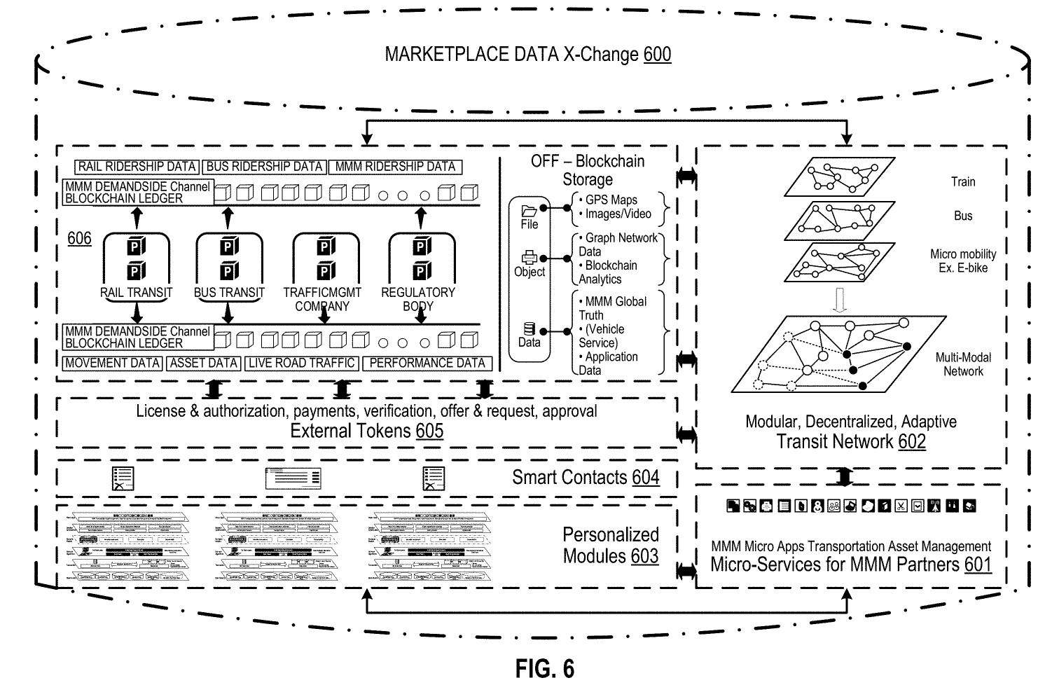

FIG. 6 illustrates the framework deployment strategy that facilitates an interoperable interface between the modes of transit and ensures a single truth visibility across the travel value chain, in accordance with an example implementation. Specifically, FIG. 6 illustrates an example of the marketplace data exchange 600 that can be facilitated through the blockchain implementations as described in FIG. 5.

At the top layer of the framework deployment strategy, there are microservices for MMM partners 601 as well as personalized modules 603 for each organization. The marketplace data exchange 600 manages smart contracts 604 between the organizations, as well as external tokens 605 to facilitate licenses, authorization, payments, verification, approval of smart contracts, and/or offer and request of smart contracts. The marketplace data exchange 600 also includes off-chain data and blockchain data 606, which is utilized to create the transit network 602. The transit network 602 creates transit networks for each of the modal organization. The transit network 602 generates a multi-modal network based on the individual transit modes, and the blockchain based decentralized implementation provides option to handle the transit services in both modular and integrated fashion based on the level of visibility. The modular handling of transit network with global multimodal network visibility enables the framework to provide analytics solutions for mode specific objective and also with an overview towards integrated multimodal transit network objectives.

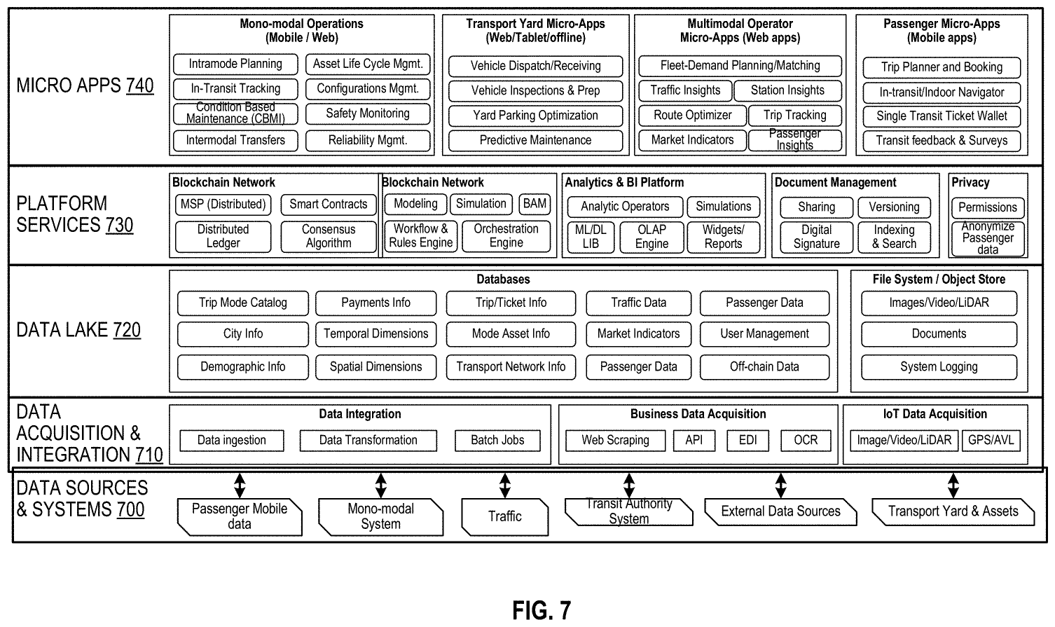

FIG. 7 illustrates an example of sample services and outputs through the framework proposed herein. Specifically, FIG. 7 illustrates an example of services that can be implemented on the proposed framework. The data sources and systems 700 that can be ingested through the framework can include, but is not limited to, such data sources as passenger mobile data, mono-modal system data, transit authority system data, transport yard/asset data, and other external data sources in accordance with the desired implementation. Examples of services that can be provided through the data acquisition and integration 710 layer of the framework can include, but is not limited to, data integration (e.g., data ingestion, data transformation, batch jobs), business data acquisition (e.g., web scraping, application programming interfaces, optical character recognition, electronic data interchange), and IoT data acquisition (e.g., via camera images, video, LiDAR, GPS, etc.). The data lake 720 can facilitate the storage of various databases, file systems, and object stores for each of the multi-modal organizations as illustrated in FIG. 7. Platform services 730 can include various services to facilitate blockchain implementations, analytics execution, document management, and privacy in accordance with the desired implementation. Micro applications 740 can include various micro-services to facilitate applications such as, but not limited to, applications for mono-modal operations, transport yard micro applications, multi-modal operator applications and passenger micro applications.

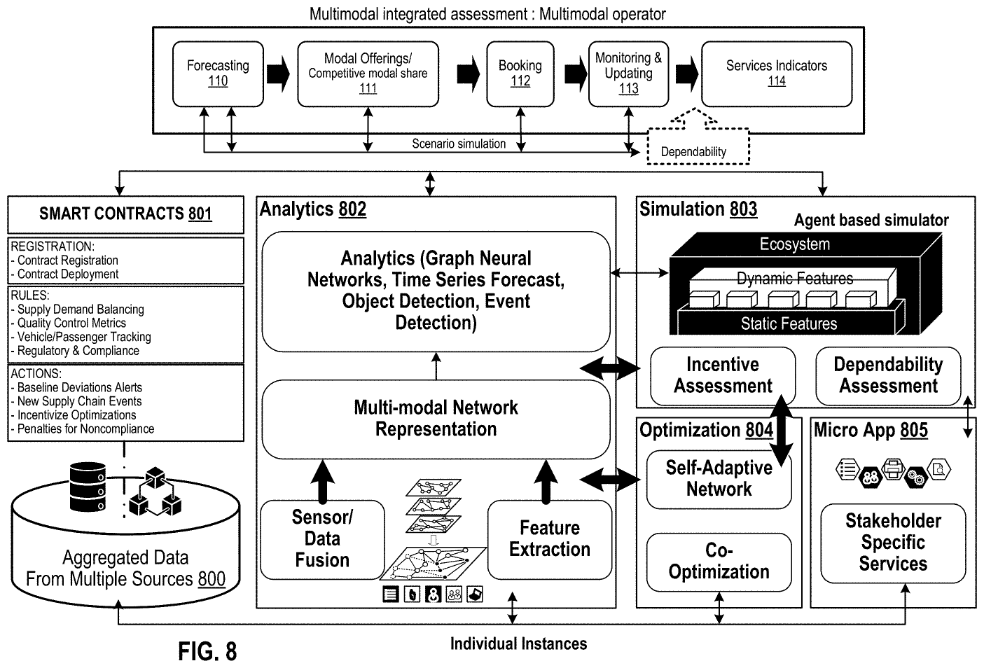

FIG. 8 illustrates an example workflow of the system in accordance with an example implementation. To facilitate the flow of FIG. 1(B), smart contracts 801 are executed between various organizations, and data aggregation from multiple sources 800 is conducted, which can involve multi-modal data (e.g., video data, time/space data, unstructured documents from regulators, etc.) which is analyzed by a co-optimization function 804 to be integrated and analyzed by analytics 802. The analytics can conduct sensor data fusion and feature extraction to generate the corresponding graph models and create a network that represents the entire multi-modal network. Upon this platform, simulations 803 can be executed and results can be provided to corresponding micro-services 805.

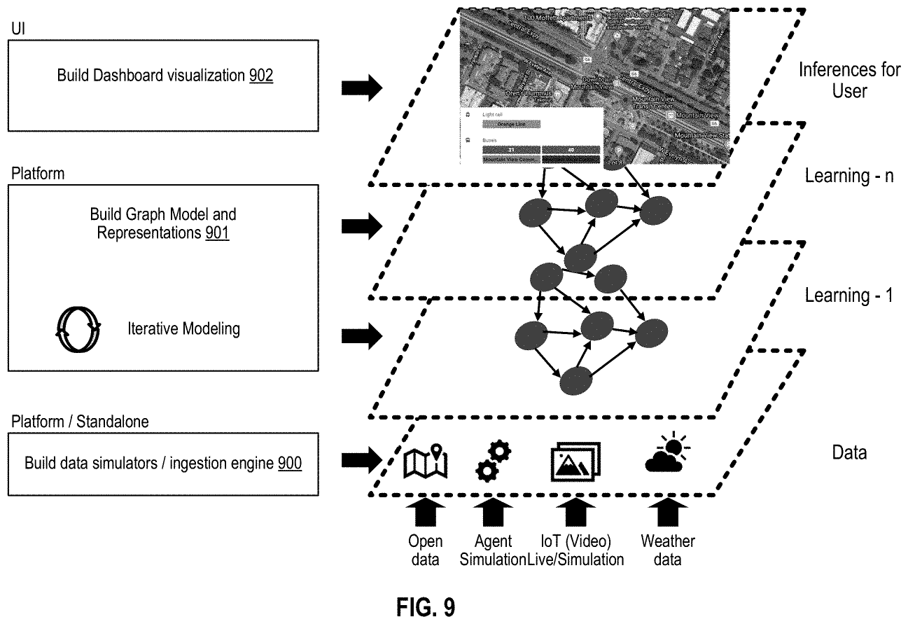

FIG. 9 illustrates an example execution between MMM planners and an operations manager, in accordance with an example implementation. Specifically, FIG. 9 illustrates an example execution to generate the analytical models and formulate a dashboard visualization. At first, data such as open data, agent simulation data, IoT data (live or simulation), and weather data is used to build data simulators or be provided into the ingestion engine 900, either through the framework as implemented in the platform as described herein or through the standalone implementation of a framework by an organization.

At 901, the execution builds graph models and representations in the form of the graph networks at described herein on the platform executing the framework. The graph models are constructed through iterative modeling. Examples of graph models that can be constructed can be MMM trip reliability due to disruptions from asset failure, weather, road closure, and so on, and MMM passenger miles travelled.

At 902, a dashboard visualization can be constructed on the user interface (UI) layer of the framework. Such visualizations can involve a geospatial display or inference for an MMM planner or operations manager.

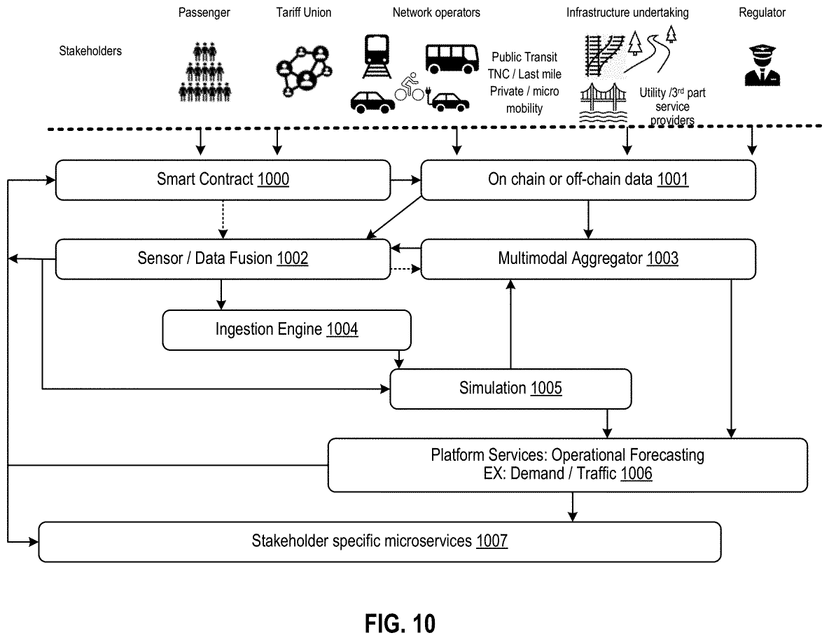

FIG. 10 illustrates an example workflow for the analytics, in accordance with an example implementation. As illustrated in FIG. 10, there are different stakeholders in the system (e.g., passengers, regulators, etc.), each of which operate and execute decisions based on the smart contract 1000. To maintain the decentralization of the system, the exchange of on-chain/off chain data 1001 are facilitated between the stakeholders before analytics is conducted so that the stakeholders can obtain data from other organizations and adjust accordingly, and feedback can be provided to the smart contract 1000. The stakeholders can thereby make decisions based on what set of data they want to visualize or use to build analytics.

Sets of data can be selected by stakeholders and provided to the ingestion engine 1004, which can incorporate data from sensor/data fusion 1002 or multimodal aggregators 1003 so as to ensure complete sets of data for the simulation 1005, including accommodations for missing data as needed. Simulation 1005 simulates various scenarios as desired by the stakeholders so as to determine physical world impact of the decisions made and can be provided to platform services/operational forecasting 1006 for execution of analytics. The final outputs can be provided to stakeholder specific microservices 1007 so as to be delivered to the stakeholders once processed.

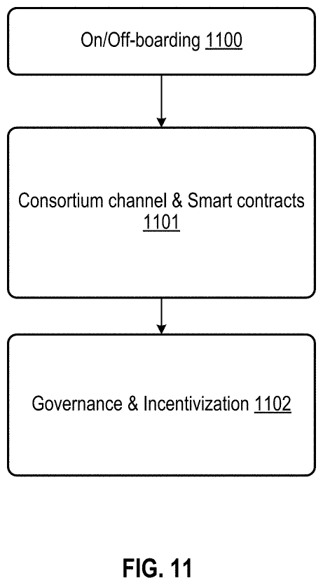

FIG. 11 illustrates examples of functional decisions, in accordance with an example implementation. Specifically, FIG. 11 illustrates examples of functional decisions that can be facilitated by the proposed framework.

At first, there is on/off boarding of organizations in the MAIM blockchain consortium and the establishment of the blockchain consortium at 1100. Such decisions can be conducted through a representative election, and can be an off-chain or on-chain data decision in accordance with the desired implementation. At 1101, there can be smart contract formulation through the consortium channel. Among the organizations in the MMM consortium, there can be data capture and exchange, data/sensor fusion, feature extraction, network formulation, smart contract governed modular handling, and channel specific data visualization. At 1102, the MAIM consortium facilitates governance and incentivization through the frame work by executing operational analytics and providing reporting to the members of the consortium in the form of competitive modal sharing, selects policies for integrated modular operation, and facilitates co-operation and synchronized execution.

Through example implementations described herein, there are strategic capabilities that can be derive from the framework, such as multimodal collaborative and competitive offerings for the participating entities, mode specific performance management, network (re)design and analysis for urban planning purpose, service/contract management, as well as for facilitating informed investments based on transit ridership analytics. Tactical capabilities derived from the framework can involve capacity management, resource management, rate and tariff management, new services and co-operations. Operational capabilities provided by the framework can involve traffic/congestion management, dynamic-demand responsive route scheduling, fleet and resource operator dispatching, predictive-prescriptive maintenance scheduling and resource allocation, as well as operational cost optimization.

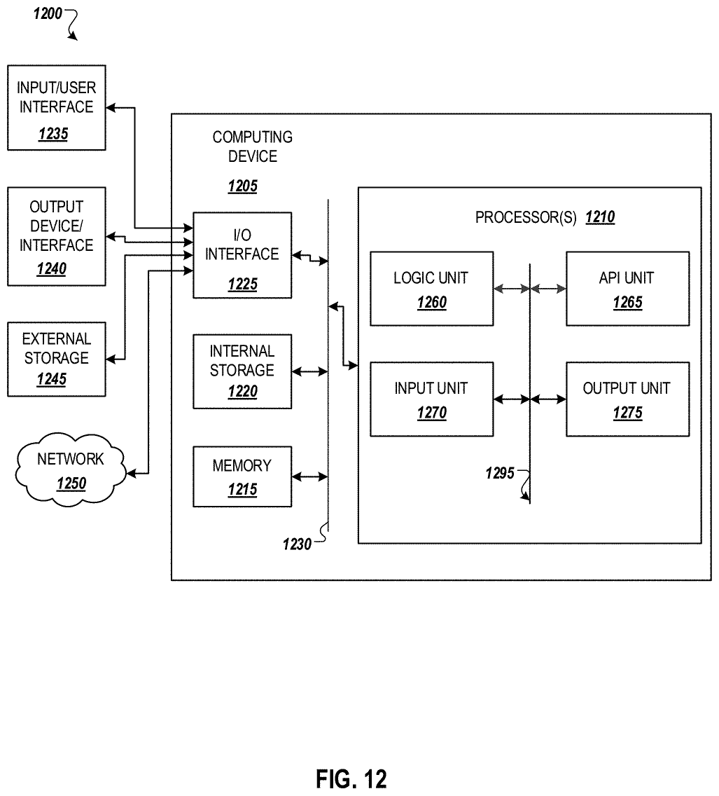

FIG. 12 illustrates an example computing environment with an example computer device suitable for use in some example implementations.

Computer device 1205 in computing environment 1200 can include one or more processing units, cores, or processors 1210, memory 1215 (e.g., RAM, ROM, and/or the like), internal storage 1220 (e.g., magnetic, optical, solid state storage, and/or organic), and/or I/O interface 1225, any of which can be coupled on a communication mechanism or bus 1230 for communicating information or embedded in the computer device 1205. I/O interface 1225 is also configured to receive images from cameras or provide images to projectors or displays, depending on the desired implementation.

Computer device 1205 can be communicatively coupled to input/user interface 1235 and output device/interface 1240. Either one or both of input/user interface 1235 and output device/interface 1240 can be a wired or wireless interface and can be detachable. Input/user interface 1235 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1240 may include a display, television, monitor, printer, speaker, braille, or the like. In some example implementations, input/user interface 1235 and output device/interface 1240 can be embedded with or physically coupled to the computer device 1205. In other example implementations, other computer devices may function as or provide the functions of input/user interface 1235 and output device/interface 1240 for a computer device 1205.

Examples of computer device 1205 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1205 can be communicatively coupled (e.g., via I/O interface 1225) to external storage 1245 and network 1250 for communicating with any number of networked components, devices, and systems, including one or more computer devices of the same or different configuration. Computer device 1205 or any connected computer device can be functioning as, providing services of, or referred to as a server, client, thin server, general machine, special-purpose machine, or another label.

I/O interface 1225 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1200. Network 1250 can be any network or combination of networks (e.g., the Internet, local area network, wide area network, a telephonic network, a cellular network, satellite network, and the like).

Computer device 1205 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 1205 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1210 can execute under any operating system (OS) (not shown), in a native or virtual environment. One or more applications can be deployed that include logic unit 1260, application programming interface (API) unit 1265, input unit 1270, output unit 1275, and inter-unit communication mechanism 1295 for the different units to communicate with each other, with the OS, and with other applications (not shown). The described units and elements can be varied in design, function, configuration, or implementation and are not limited to the descriptions provided.

In some example implementations, when information or an execution instruction is received by API unit 1265, it may be communicated to one or more other units (e.g., logic unit 1260, input unit 1270, output unit 1275). In some instances, logic unit 1260 may be configured to control the information flow among the units and direct the services provided by API unit 1265, input unit 1270, output unit 1275, in some example implementations described above. For example, the flow of one or more processes or implementations may be controlled by logic unit 1260 alone or in conjunction with API unit 1265. The input unit 1270 may be configured to obtain input for the calculations described in the example implementations, and the output unit 1275 may be configured to provide output based on the calculations described in example implementations.

Processor(s) 1210 can be configured to establishing a blockchain network between a plurality of organizations, each organization representing a different mode of transport as illustrated in FIG. 5; derive multi-modal features from first data sources of the plurality of organizations in the blockchain and second data sources off the blockchain as illustrated in FIG. 2; construct a multi-modal network that integrates the different mode of transports from the plurality of organizations from the derived multi-modal features as illustrated in FIGS. 3-4 and 6; execute smart contracts between the plurality of organizations across the blockchain in accordance with service level agreements generated from reinforcement learning through the multi-modal model derived from the multi-modal network as illustrated in FIG. 6-11; and provide, through a micro-application, access to multi-modal transportation services based on the executed smart contracts as illustrated in FIG. 7.

Processor(s) 1210 can be configured to derive multi-modal features from the first data sources and the second data sources by conducting sensor fusion on multi-modal sensor data from the first sources and the second sources as illustrated in FIG. 2.

Processor(s) 1210 can be configured to facilitate a platform configured to conduct analytics on the multi-modal transportation services based on the derived multi-modal features as illustrated in FIG. 2 and FIG. 8.

In example implementations, the first data sources and the second data sources are from multiple modes of transportation and wherein the processor(s) 1210 can be configured to conduct data intake from the first data sources and the second data sources as illustrated in FIGS. 2 and 8.

In example implementations, the service level agreements can involve incentivized agreements bundling data exchange or operations across a plurality of modes of transport associated with one or more of the plurality of organizations as illustrated in FIG. 6-11.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method, comprising:
establishing a blockchain network between a plurality of organizations, each organization representing a different mode of transport;
deriving multi-modal features from first data sources of the plurality of organizations in the blockchain and second data sources off the blockchain;
constructing a multi-modal network that integrates the different mode of transports from the plurality of organizations from the derived multi-modal features;
executing smart contracts between the plurality of organizations across the blockchain in accordance with service level agreements generated from reinforcement learning through the multi-modal model derived from the multi-modal network; and
providing, through a micro-application, access to multi-modal transportation services based on the executed smart contracts.

2. The method of claim 1, wherein the deriving multi-modal features from the first data sources and the second data sources comprises conducting sensor fusion on multi-modal sensor data from the first sources and the second sources.

3. The method of claim 1, further comprising facilitating a platform configured to conduct analytics on the multi-modal transportation services based on the derived multi-modal features.

4. The method of claim 1, wherein the first data sources and the second data sources are from multiple modes of transportation and wherein the method further comprises conducting data intake from the first data sources and the second data sources.

5. The method of claim 1, wherein the service level agreements comprise incentivized agreements bundling data exchange or operations across a plurality of modes of transport associated with one or more of the plurality of organizations.

6. A non-transitory computer readable medium, storing instructions for executing a process, the instructions comprising:
establishing blockchain network between a plurality of organizations, each organization representing a different mode of transport;
deriving multi-modal features from first data sources of the plurality of organizations in the blockchain and second data sources off the blockchain;
constructing a multi-modal network that integrates the different mode of transports from the plurality of organizations from the derived multi-modal features;
executing smart contracts between the plurality of organizations across the blockchain in accordance with service level agreements generated from reinforcement learning through the multi-modal model derived from the multi-modal network; and
providing, through a micro-application, access to multi-modal transportation services based on the executed smart contracts.

7. The non-transitory computer readable medium of claim 6, wherein the deriving multi-modal features from the first data sources and the second data sources comprises conducting sensor fusion on multi-modal sensor data from the first sources and the second sources.

8. The non-transitory computer readable medium of claim 6, further comprising facilitating a platform configured to conduct analytics on the multi-modal transportation services based on the derived multi-modal features.

9. The non-transitory computer readable medium of claim 6, wherein the first data sources and the second data sources are from multiple modes of transportation and wherein the method further comprises conducting data intake from the first data sources and the second data sources.

10. The non-transitory computer readable medium of claim 6, wherein the service level agreements comprise incentivized agreements bundling data exchange or operations across a plurality of modes of transport associated with one or more of the plurality of organizations.
